(19) United States
(12) Patent Application Publication
(10) Pub. No.: US 2011/0084675 A1
(43) Pub. Date: Apr. 14, 2011

(54) BOOSTER CIRCUIT

(75) Inventor: Hirokazu Kawagoshi, Kanagawa (JP)

(73) Assignee: Renesas Electronics Corporation

(21) Appl. No.: 12/889,930

(22) Filed: Sep. 24, 2010

(30) Foreign Application Priority Data
Oct. 8, 2009 (JP) 2009-234213

(51) Int. Cl. G05F 1/46

(52) U.S. Cl. 323/282

(57) ABSTRACT

A booster circuit according to the present invention includes a booster that connects a boosting condenser that is charged and a direct-current power source in series through a switch for a boosting operation in order to generate a boosted voltage and charges a smoothing condenser with the boosted voltage through a switch for an outputting operation. The switch for the boosting operation is composed of a plurality of switches connected in parallel and at least one of the plurality of switches can be controlled independently.

### INCORPORATION BY REFERENCE

This application is based upon and claims the benefit of priority from Japanese patent application No. 2009-234213, filed on Oct. 8, 2009, the disclosure of which is incorporated herein in its entirety by reference.

### BACKGROUND

1. Field of the Invention

The present invention relates to a charge pump type booster circuit, and more particularly, it relates to a booster circuit having a function of performing negative feed back to set an output of a charge pump to be a desired voltage.

2. Description of Related Art

A mobile device such as a cellular phone or a Personal Digital Assistant (PDA) generally includes a display panel that displays information and a driving circuit (a driving IC) that drives the display panel composed of semiconductor integrated circuits (ICs). In the mobile device, a relatively low-voltage battery is employed as an external power supply. However, the display panel usually requires higher driving voltage than the battery voltage. The driving IC generally includes a booster circuit that boosts the battery voltage to generate the required driving voltage.

An example of the booster circuit as described above is disclosed in Japanese Unexamined Patent Application Publication No. 2007-20247. This booster circuit 1 is a charge pump type and includes a charge pump 10 and a regulator 20 as shown in FIG. 1. The regulator 20 skips the clock signal CLK1, that controls the charge pump 10 to perform a boosting operation, according to an output voltage Vₒᵤₜ of the charge pump 10. In this way, the booster circuit 1 makes the charge pump 10 to output a voltage (a desired voltage) which is boosted from a source voltage VDD.

The charge pump 10 includes switches SW1 to SW3, SW4a, SW4b, a resistor R3, a boosting condenser C1 and a smoothing condenser C2. The switches SW1 to SW3, SW4a, and SW4b are each controlled according to signals received from the regulator 20. The charge pump 10 applies the source voltage VDD to the boosting condenser C1 for charging the boosting condenser C1 using the switches SW1 and SW2. Hereinafter, this operation is referred to as a charging operation. The charge pump 10 applies the source voltage VDD to a lower side of the charged boosting condenser C1 and boosts the source voltage VDD by a charged voltage of the boosting condenser C1 using the switch SW3. Hereinafter, this operation is referred to as a boosting operation. The charge pump 10 applies the boosted voltage to the smoothing condenser C2 using the switch SW4a or the switch SW4b through the resistor R3 for smoothing a boosted voltage, and supplies an output voltage Vₒᵤₜ to a load circuit (not shown). Hereinafter, this operation is referred to as an outputting operation. The boosting operation and the outputting operation are performed concurrently. The charging operation and a set of the boosting operation and the outputting operation are performed complementary.

The regulator 20 includes a voltage-dividing circuit 21, comparators 22 and 23 and an AND circuit 24. The voltage-dividing circuit 21 includes resistors R1 and R2 that divide the output voltage Vₒᵤₜ from the charge pump 10 and supplies a divided voltage Vd1 from a divided point P1 between the resistors R1 and R2 to the comparator 22. The resistor R1 is divided into resistors R1a and R1b. A divided voltage Vd2 is supplied from a divided point P2 between the resistors R1a and R1b to the comparator 23. The comparators 22 and 23 compare the divided voltages Vd1 and Vd2 to a reference voltage Vref and output a comparative result CPS1 to the AND circuit 24 and a comparative result CPS2 to the charge pump 10. When the comparator 22 detects that the output voltage becomes the desired voltage, the comparative result CPS1 turns from H-level to L-level. When the comparator 23 detects that the output voltage becomes a value lower than the desired voltage by a predetermined value, the comparative result CPS2 turns from H-level to L-level. The AND circuit 24 performs logical multiplication between the clock signal CLK1 and the comparative result CPS1 and supplies a clock signal CLK2 to the charge pump 10.

In the charge pump 10, the switches SW1 to SW3, SW4a, and SW4b are controlled according to the clock signal CLK2 and the comparative result CPS2. A set of the switches SW1 and SW2 and the switch SW3 are complementary set to be ON-state or OFF-state according to the received clock signal CLK2. When the received clock signal CLK2 is H-level, the switches SW4a and SW4b are complementary set to be ON-state or OFF-state by the comparative result CPS2. When the received clock signal CLK2 is L-level, the switches SW4a and SW4b are set to be OFF-state.

According to the above described configuration, the booster circuit 1 performs the outputting operation using the switch SW4a when the output voltage Vₒᵤₜ is lower than a detected voltage which is detected in the comparator 23. The booster circuit 1 performs the outputting operation using the switch SW4b through the resistor R3 when the output voltage Vₒᵤₜ is equal to or higher than the detected voltage. As a result, a charging curve of the smoothing condenser C2 becomes gentle. In this configuration, overshoot and ripple in the output voltage Vₒᵤₜ can be reduced just before the output voltage Vₒᵤₜ becomes the desired voltage.

### SUMMARY

The booster circuit 1 as described above is configured to reduce overshoot and ripple in the output voltage Vₒᵤₜ at a lightly-loaded period. However, the present inventors have found a following problem. Usually, rated voltages of the switches SW4a and SW4b that perform the outputting operation in the booster circuit 1 are designed to be higher than the output voltage Vₒᵤₜ. In other words, the desired voltage of the output voltage Vₒᵤₜ is designed to be lower than the rated voltage of the switches SW4a and SW4b. However, at the time when the switch SW3 and the switch SW4a or 4b are ON and the booster circuit 1 changes from the charging operation to the boosting and the outputting operations, a higher side of the boosting condenser C1 is raised to a sum of the source voltage VDD and the charged voltage of the boosting condenser C1 caused by the ON-resistance of the switch SW4a or SW4b. When the switches SW4a and SW4b are composed of P-channel type MOS transistors, gate voltages of the MOS transistors are controlled to be a ground voltage. Therefore, there is a problem that a gate-source voltage of the MOS transistors becomes over the rated voltage until the comparator 22 begins to skip the clock signal CLK1 depending on a designed rated voltage of the source-gate voltage in the MOS transistors constituting the switches SW4a and SW4b. Particularly, this problem may be raised in the lightly-loaded period.

A first exemplary aspect of the present invention is a booster circuit which includes: a booster that connects a charged boosting condenser and a direct-current power source in series through a switch for a boosting operation to generate a boosted voltage and charges a smoothing condenser with the boosted voltage through a switch for an outputting operation. The switch for the boosting operation is composed of a plurality of switches connected in parallel and at least one of the plurality of switches can be controlled independently.

In the above mentioned configuration, the booster circuit connects the charged boosting condenser with the direct-current power source in series through a switch for a boosting operation and boosts the direct-current power source with the charged voltage in the boosting condenser (the operation referred to as a boosting operation). Therefore, a boosting voltage curve in the higher side of the boosting condenser can be made gentle.

A second exemplary aspect of the present invention is a booster circuit includes a boosting condenser; and a control circuit that switches a charging operation and a boosting operation, the charging operation is the one in which the boosting condenser is connected to a first path between a first voltage and a second voltage lower than the first voltage to charge the boosting condenser, a boosting operation is the one in which a connection destination of a lower side of the charged boosting condenser is switched from the second voltage to the first voltage or a third voltage higher than the first voltage to generate a boosted voltage at a higher side of the boosting condenser. The control circuit varies a resistance of a boosting path that connects the lower side of the boosting condenser with the first voltage or the third voltage according to a voltage in the higher side of the boosting condenser in the boosting operation.

In the above mentioned configuration, when the voltage in the higher side of the boosting condenser is higher than the reference value, the booster circuit, for example, sets the resistance of the boosting path to be larger than the resistance at a time when the voltage of the higher side of the boosting condenser is lower than the reference value. Therefore, the boosting voltage curve in the higher side of the boosting condenser can be changed gently.

The present invention can provide the booster circuit that prevents a voltage higher than the rated voltage from being applied to the switch for an outputting operation that outputs a voltage lower than a sum of the direct current source voltage and the charged voltage through the switch for the outputting operation. As a result, it can prevent degradation of switches constituting the charge pump.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a circuit diagram showing a booster circuit 1 according to a related art;

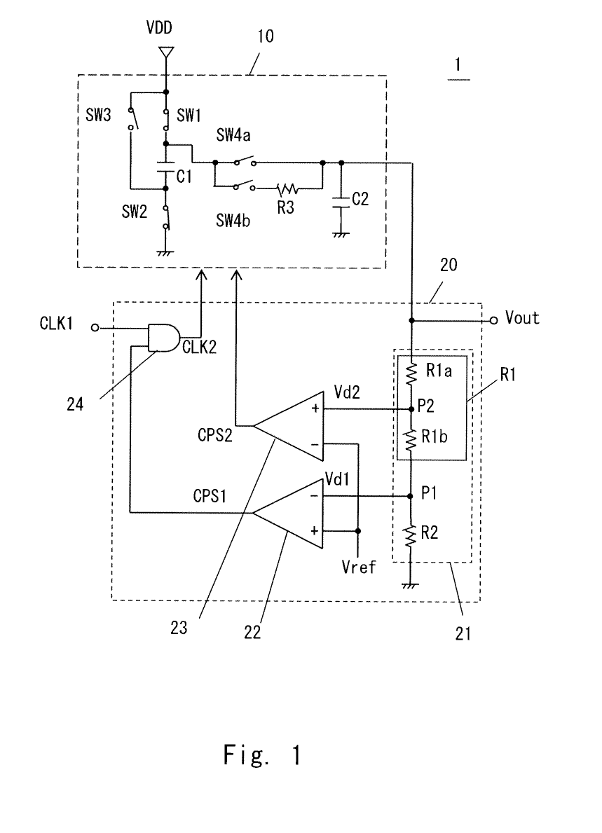

FIG. 2 is a circuit diagram showing a booster circuit 2 according to a first exemplary embodiment in the present invention;

FIG. 3 is a waveform chart showing an operation of the booster circuit 2 shown in FIG. 2;

FIG. 4 is a circuit diagram showing a booster circuit 3 according to a second exemplary embodiment in the present invention;

FIG. 5 is a circuit diagram showing a booster circuit 4 according to a third exemplary embodiment in the present invention; and

FIG. 6 is a waveform chart showing an operation of the booster circuit 4 shown in FIG. 5.

### DETAILED DESCRIPTION OF THE EXEMPLARY EMBODIMENTS

### First Exemplary Embodiment

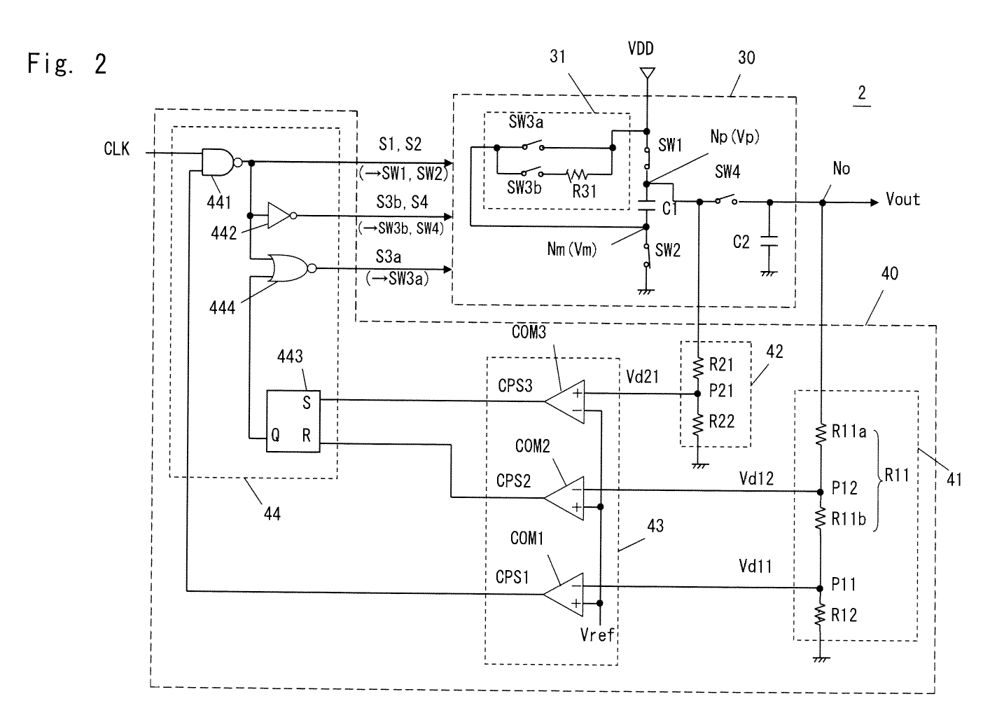

Referring to drawings, a booster circuit according to a first exemplary embodiment will be described. The booster circuit is assembled together with other functional blocks into an IC chip such as a driving IC that drives a display panel, for example. FIG. 2 shows a circuit diagram showing a booster circuit 2 according to the first exemplary embodiment in the present invention. The booster circuit 2 is charge pump type and includes a charge pump 30 and a regulator 40. The booster circuit 2 boosts a source voltage VDD to a desired boosted voltage (a desired voltage) and supplies it to a load circuit (not shown) as an output voltage Vₒᵤₜ.

The charge pump 30 includes switches SW1, SW2, SW3a, SW3b, SW4, a resistor R31, a boosting condenser C1 and a smoothing condenser C2. The switch SW1 is connected between a source voltage VDD and a connection node Np. The switch S2 is connected between a connection node Nm and a ground voltage Gnd. A switch for the boosting operation 31 is composed of the switches SW3a and SW3b, and the resistor R31. In the switch for the boosting operation 31, the switch SW3a and the switch SW3b through the resistor R31 are connected in parallel. The switch for the boosting operation 31 is connected between the source voltage VDD and the connection node Nm. The switch SW4 is connected between the connection node Np and an output node No. The boosting condenser C1 is connected between the connection node Np and the connection node Nm. The smoothing condenser C2 is connected between the output node No and the ground voltage Gnd. The switches SW1, SW2, SW3a, SW3b and SW4 are composed of MOS transistors. The resistor R31 can be composed of an ON-resistance of the switch SW3b. In this case, it is only necessary to design the ON-resistance of the switch SW3b to be larger than an ON-resistance of the switch SW3a. The boosting condenser C1 and the smoothing condenser C2 are connected as external components to the IC chip.

The switches SW1, SW2, SW3a. SW3b, and SW4 are respectively controlled by control signals S1, S2, S3a, S3b and S4 supplied from the regulator 40. The switches SW1, SW2, SW3a, SW3b and SW4 turn ON at H-level in the control signals S1, S2, S3a, S3b and S4 and turn OFF at L-level in the control signals. The charge pump 30 sets the switches SW1 and SW2 to ON-state and the switch SW3a and SW3b to OFF-state and makes the boosting condenser C1 to be connected in series with the source voltage VDD to charge the boosting condenser C1 with the source voltage VDD. Hereinafter, this operation is referred to as a charging operation. A voltage Vp of the connection node Np is equal to a charged voltage Vc of the boosting condenser C1 by the charging operation. When a charging of the boosting condenser C1 is saturated, the charged voltage Vc is approximately equal to the source voltage VDD.

The charge pump 30 sets the switches SW1 and SW2 to be OFF-state and the switch SW3a or the switch SW3b to be ON-state so that the boosting condenser C1 is connected in series with the source voltage VDD at the connection node Nm. The charge pump 30 supplies a boosted voltage from the connection node Np as a boosted voltage Vu. Hereinafter, this operation is referred to as a boosting operation. The boosted voltage Vu, that is the voltage Vp of the connection node Np is a sum of the source voltage VDD and the charged voltage Vc by the boosting operation. The switch SW3b performs a boosting operation through the resistor R31. The switch SW3b may be set to be OFF-state at performing a boosting operation by the switch SW3a, but the switch SW3b is set to be ON-state in this embodiment.

The charge pump 30 sets the switch SW4 to be ON-state, and smoothes the boosted voltage Vu supplied from the connection node Np by the smoothing condenser C2. The charge pump 30 supplies a smoothed voltage to the load circuit (not shown) as the output voltage Vₒᵤₜ from the output node No. Hereinafter, this operation is referred to as an outputting operation. The boosting operation and the outputting operation are performed concurrently. The charging operation and a set of the boosting operation and the outputting operation are performed complementally.

An operation of the charge pump 30 will be described. Firstly, the charge pump 30 receives H-level control signals S1 and S2 and L-level control signals S3a, S3b and S4. The switches SW1 and SW2 turn ON and the switches SW3a, SW3b and SW4 turn OFF. Therefore, the charge pump 30 is in the charging operation. Next, the charge pump 30 receives L-level control signals S1 and S2 and H-level control signals S3a, S3b and S4. The switches SW1 and SW2 turn OFF and the switches SW3a, SW3b and SW4 turn ON. Therefore, the charge pump 30 is in a first stage of the boosting operation because of the ON-state in the switches SW3a and SW3b and is in the outputting operation because of the ON-state in the switch SW4. The charge pump 30 receives L-level control signals S1, S2 and S3a and H-level control signals S3b and S4. The switches SW1, SW2 and SW3a turn OFF and the switches SW3b and SW4 turn ON. Therefore, the charge pump 30 is in a second stage of the boosting operation because of the ON-state in the switch SW3b through the resistor R31 and is in the outputting operation because of the ON-state in the switch SW4. That is, in the first stage of the boosting operation, a lower side of the boosting condenser C1 and the source voltage VDD are connected through a path including the switch SW3a. On the other hand, in the second stage of the boosting operation, the lower side of the boosting condenser C1 and the source voltage VDD are connected through a path including the switch SW3b and the resistor R31. Because of a given time constant of the resistor R31, a boosting voltage curve in the boosted voltage Vu, that is a voltage Vp of the connection node Np in the second stage of the boosting operation is gentler than that in the first stage of the boosting operation.

The regulator 40 includes a first voltage-dividing circuit 41, a second voltage-dividing circuit 42, a comparator 43 and a control signal generating circuit 44. The first voltage-dividing circuit 41 includes resistors R11 and R12 that divide the output voltage Vₒᵤₜ supplied from the charge pump 30. The resistor R11 is divided into resistors R11a and R11b. The resistors R11 and R12 are connected in series between the output node No of the charge pump 30 and the ground voltage Gnd. The first voltage-dividing circuit 41 supplies a divided voltage Vd11 from a divided point P11 between the resistors R11 and R12 to the comparator 43. The first voltage-dividing circuit 41 supplies a divided voltage Vd12 from a divided point P12 between the resistors R11a and R11b to the comparator 43. The second voltage-dividing circuit 42 includes resistors R21 and R22 that divide the voltage Vp in the connection node Np. The resistors R21 and R22 are connected in series between the connection node Np and the ground voltage Gnd. The second voltage-dividing circuit 42 supplies a divided voltage Vd21 from a divided point P21 between the resistors R21 and R22 to the comparator 43. The divided voltages Vd11, Vd12 and Vd21 are given as follows. Resistance values in the resistors R11, R11a, R11b, R12, R21 and R22 are represented by R11, R11a, R11b, R12, R21 and R22, respectively.

Vd11=Vₒᵤₜ×R12/(R11+R12)

Vd12=Vₒᵤₜ×(R11b+R12)/(R11+R12)

Vd21=Vₒᵤₜ×R22/(R21+R22)

The comparator 43 includes comparators COM1, COM2 and COM3 and compares the divided voltages Vd11, Vd12 and Vd21 with a reference voltage Vref to supply comparative results CPS1, CPS2 and CPS3 to the control signal generating circuit 44. In the comparators COM1 and COM2, the divided voltages Vd11 and Vd12 are applied to inverting input terminals and the reference voltage Vref is applied to non-inverting input terminals. In the comparator COM3, the divided voltage Vd21 is applied to a non-inverting input terminal and the reference voltage Vref is applied to an inverting input terminal. The output voltage Vₒᵤₜ, that is the voltage Vp in the connection node is detected as voltages V1, V2 and V3 by the comparators COM1, COM2 and COM3. The voltages V1, V2 and V3 are given as follows.

V1=Vref×(1+R11/R12)

V2=Vref×{1+R11a/(R11b+R12)}

V3=Vref×(1+R21/R22)

For instance, when a rated voltage of the switch SW4 is assumed as a reference (100%)/0), the voltage V1 is designed to be 92% of the rated voltage of the switch SW4 as a desired boosted voltage of the output voltage Vₒᵤₜ. The voltage V2 is designed to be 90% of the rated voltage of the switch SW4 and the voltage V3 (V3>V2) to be 95% of the rated voltage of the switch SW4. For example, when the rated voltage of the switch SW4 is 6.0 V, the voltages V1, V2 and V3 are designed as V1=6.0×92%=5.5 V, V2=6.0×90%=5.4 V and V3=6.0×95%=5.7 V. Further, when the reference voltage Vref is 2.75 V, the resistor R11 may be designed to be equal to the resistor R12 to set the voltage V1 to be 5.5 V. Further, a ratio of the resistor R11a and R11b may be designed as R11a: R11b=53:1 for setting the voltage V2=5.4 V. A ratio of the resistor R21 and R22 may be designed as R21:R22=59:55 for setting the voltage V3=5.7 V.

The control signal generating circuit 44 includes a NAND circuit 441, a NOT circuit 442, an RS flip-flop circuit 443 and a NOR circuit 444. The control signal generating circuit 44 performs logic operation between a boosting clock CLK, and the comparative results CPS1. CPS2 and CPS3 and supplies the control signals S1, S2, S3a, S3b and S4 to the charge pump 30. The NAND circuit 441 performs negative AND between the boosting clock CLK and the comparative result CPS1 and supplies the operation result to the charge pump 30 as the control signals S1 and S2. The NAND circuit 441 supplies the operation result also to the NOT circuit 442 and the NOR circuit 444. The NOT circuit 442 inverts the output of the NAND circuit 441 and supplies the inverted signal to the charge pump 30 as the control signals S3b and S4. The RS flip-flop circuit 443 receives the comparative result CPS3 at a set terminal S and the comparative result CPS2 at a reset terminal R and supplies the signal from the output terminal Q to the NOR circuit 444. The NOR circuit 444 performs NOR between an output of the output terminal Q and an output of the NAND circuit 441 and supplies the operation result to the charge pump 30 as the control signal 53a.

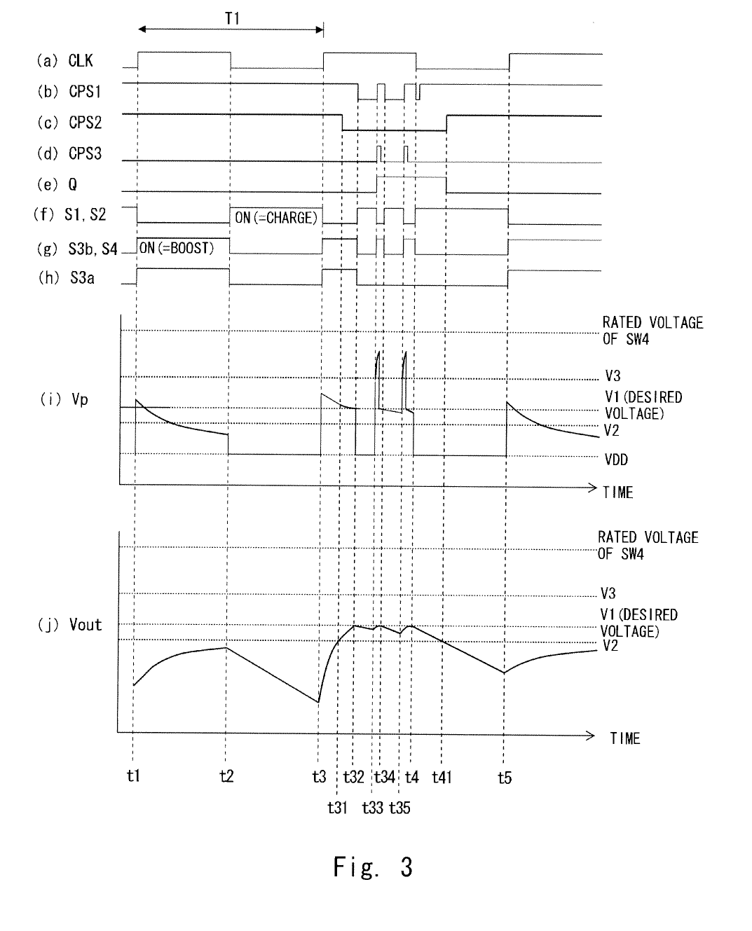

An operation of the booster circuit 2 as described above will be explained referring to FIG. 3. In an operation status (time t1 to t5) of the booster circuit 2, the booster circuit 2 receives the source voltage VDD, the reference voltage Vref and the ground voltage Gnd. In the operation status, the booster circuit 2 also receives the boosting clock CLK having a period T1 in which the boosting clock is logic H-level (referred to as just H-level) in time t1 to t2 and t3 to t4 and logic L-level (referred to as just L-level) in time t2 to t3 and t4 to t5 as shown in FIG. 3(a). In the operation status, the booster circuit 2 supplies the output voltage Vₒᵤₜ shown in FIG. 3(j) to the load circuit (not shown).

A voltage of the output node No, that is the output voltage Vₒᵤₜ is divided by the first voltage-dividing circuit 41 and a divide voltage is supplied to the comparator 43 as the divided voltages Vd11 and Vd12 from the first voltage-dividing circuit 41. The voltage Vp of the connection node Np is divided by the second voltage-dividing circuit 42 and a divided voltage is supplied to the comparator 43 as the divided voltage Vd21 from the second voltage-dividing circuit 42. The divided voltages Vd11, Vd12 and Vd21 are compared with the reference voltage Vref by the comparators COM1, COM2 and COM3 in the comparator 43. The divided voltages Vd11, Vd12 and Vd21 are output as the comparison results CPS1, CPS2 and CPS3 which are based on the output voltage Vₒᵤₜ and the voltage Vp as shown in FIGS. 3(b), 3(c) and 3(d).

The boosting clock CLK is supplied to the control signal generating circuit 44. In the control signal generating circuit 44, the NAND circuit 441 performs logical NAND between the boosting clock CLK and the comparison result CPS1 which is based on the output voltage Vₒᵤₜ. The output of the NAND circuit 441 is supplied directly as the control signals S1 and S2 as shown in FIG. 3(f) and also supplied to the NOT circuit 442 and the NOR circuit 444. An output of the NOT circuit 442 is supplied as the control signals S3b and S4 as shown in FIG. 3(g). In the control signal generating circuit 44, the RS flip-flop circuit 443 receives the comparison result CPS2 based the output voltage Vₒᵤₜ at the reset terminal R and the comparison result CPS3 based on the voltage Vp in the connection node Np at the set terminal S. The output of the output terminal Q of the RS flip-flop circuit 443 is supplied as shown in FIG. 3(e). The NOR circuit 444 receives two signals of the output of the output terminal Q and the output of the NAND circuit 441 and performs logic NOR between the output of the output terminal Q and the output of the NAND circuit 441. The output of the NOR circuit 444 is output as the control signal S3a as shown in FIG. 3(h).

The control signals S1, S2, S3a, S3b and S4 are supplied from the control signal generating circuit 44 to the charge pump 30. In the charge pump 30, the control signals S1, S2, S3a, S3b and S4 respectively control and set the switches SW1, SW2, SW3a, SW3b and SW4 to be ON-state at H-level. The charging pump 30 performs the charging operation when the switches SW1 and SW2 are ON-state and the switches SW3a, SW3b and SW4 are OFF-state. When the switches SW1 and SW2 are OFF-state, the switches SW3b and SW4 are ON-state and the switch SW3a is ON-state based on the control signal S3a determined according to the output voltage Vₒᵤₜ and the voltage Vp in the connection node Np, the charge pump 30 performs the fist stage of the boosting operation and the output operation. When the switches SW1 and SW2 are OFF-state, the switches SW3b and SW4 are ON-state and the switch SW3a is OFF-state, the charge pump 30 performs the second stage of the boosting operation and the output operation.

Hereinafter, an operation of the booster circuit 2 using the control signals S1, S2, S3a, S3b and S4 determined based on values of the output voltage Vₒᵤₜ and the voltage Vp of the connection node Np will be described.

(1) Period t1 to t2

The boosting clock CLK is H-level as shown in FIG. 3(a). Because the output voltage Vₒᵤₜ is lower than the detected voltages V1 and V2 as shown in FIG. 3(j), the comparison results CPS1 and CPS2 are H-level as shown in FIGS. 3(b) and 3(c). Therefore, the output of the NAND circuit 441 or the control signals S1 and S2 is L-level as shown in FIG. 3(f). The output of the NOT circuit 442 or the control signals S3b and S4 is H-level as shown in FIG. 3(g). Because the RS flip-flop 443 is reset by the comparison result CPS2, the output Q of the RS flip-flop 443 is L-level as shown in FIG. 3(e). Therefore, the output of the NOR circuit 444, that is the control signal S3a is H-level as shown in FIG. 3(h). As a result, in the period t1 to t2, the charge pump 30 is controlled to perform the first stage of the boosting operation and the outputting operation by the control signals S1, S2, S3a, S3b and S4.

(2) Period t2 to t3

The boosting clock CLK is L-level as shown in FIG. 3(a). Therefore, the output of the NAND circuit 441 or the control signals S1 and S2 is H-level as shown in FIG. 3(f). The output of the NOT circuit 442 or the control signals S3b and S4 is L-level as shown in FIG. 3(g). The output of the NOR circuit 444, that is the control signal S3a is L-level as shown in FIG. 3(h). As a result, in the period t2 to t3, the charge pump 30 is controlled to perform the charging operation by the control signals S1, S2, S3a, S3b and S4.

(3) Period t3 to t4

The boosting clock CLK is H-level as shown in FIG. 3(a). In the period t3 to t31, because the output voltage Vₒᵤₜ is lower than the detected voltages V1 and V2 as shown in FIG. 3(j), the control signals S1, S2, S3a, S3b and S4 are the same signal level as the period t1 to t2 as shown in FIGS. 3(f), 3(g) and 3(h). At the time t31, because the output voltage Vₒᵤₜ becomes higher than the detected voltage V2 as shown in FIG. 3(j), the comparison result CPS2 turns L-level as shown in FIG. 3(c). In a period time t31 to t32, because the voltage Vp of the connection node Np is lower than the detected voltage V3, the comparison result CPS3 remains L-level as shown in FIG. 3(d). Therefore, in this period, the output terminal Q of the RS flip-flop 443 remains L-level as shown in FIG. 3(e). In the same period, the output voltage Vₒᵤₜ is lower than the detected voltage V1 as shown in FIG. 3(j). Therefore, in the same period, the control signals S1, S2, S3a, S3b and S4 remain the same signal level as in the period t31 to t32. As a result, in the period t3 to t32, the charge pump 30 is controlled to perform the fist stage of the boosting operation and the outputting operation by the control signals S1, S2, S3a, S3b and S4.

Next, at the time t32, because the output voltage Vₒᵤₜ becomes over the detected voltage V1 as shown in FIG. 3(j), the comparison result CPS1 turns L-level as shown in FIG. 3(b). Therefore, the output of the NAND circuit 441 turns H-level and the control signals S1, S2, S3a, S3b and S4 are the same signal level as in the period t2 to t3 as shown in FIGS. 3(f), 3(g) and 3(h) until the time t33 when the comparison result CPS1 turns H-level. As a result, in a period t32 to t33, the charge pump 30 is controlled to perform the charging operation by the control signals S1, S2, S3a, S3b and S4.

At the time t33, because the output voltage Vₒᵤₜ becomes lower than the detected voltage V1 while remaining higher than the detected voltage V2, the comparison result CPS2 remains L-level as shown in FIG. 3(c) and the comparison result CPS1 turns H-level as shown in FIG. 3(b). Therefore, the output of the NAND circuit 441 turns L-level and the control signals S1, S2, S3b and S4 remain the same signal level as the period t1 to t2 as shown in FIGS. 3(f) and 3(g) until the time t34. On the other hand, just after the time t33, because the voltage Vp of the connection node Np becomes higher than the detected voltage V3 as shown in FIG. 3(i), the comparison result CPS3 turns H-level as shown in FIG. 3(d). In synchronization with this operation, the output terminal Q of the RS flip-flop 443 turns H-level as shown in FIG. 3(e) and remains H-level until the RS flip-flop 443 is reset. Therefore, until the RS flip-flop 443 is reset, the control signal S3 remains L-level as shown in FIG. 3(h). As a result, in a period t33 to t34, the charge pump 30 is controlled to perform the second stage of the boosting operation and the outputting operation by the control signals S1, S2, S3a, S3b and S4.

In a period t34 to t35, the control signals S1, S2, S3a, S3b and S4 are in the same signal level as in the period t32 to t33 as shown in FIGS. 3(f), 3(g) and 3(h). That is, in the period t34 to t35, the charge pump 30 is controlled to perform the charging operation by the control signals S1, S2, S3a, S3b and S4.

In the period t35 to t4, the control signals S1, S2, S3a, S3b and S4 are in the same signal level as in the period t33 to t34 as shown in FIGS. 3(f), 3(g) and 3(h). That is, in the period t35 to t4, the charge pump 30 is controlled to perform the second stage of the boosting operation and the outputting operation by the control signals S1, S2, S3a, S3b and S4.

(4) Period t4 to t5

The boosting clock CLK is L-level as shown in FIG. 3(a). Therefore, the output of the NAND circuit 441 turns H-level and the control signals S1, S2, S3a, S3b and S4 are in the same signal level as the period t2 to t3 as shown in FIGS. 3(f), 3(g) and 3(h). As a result, in the period t4 to t5, the charge pump 30 is controlled to perform the charging operation by the control signals S1, S2, S3a, S3b and S4.

At time t41, because the output voltage Vₒᵤₜ becomes lower than the detected voltage V2 as shown in FIG. 3(j), the comparison result CPS2 turns H-level as shown in FIG. 3(c). At this time, the RS flip-flop 443 is reset by the comparison result CPS2 and the output terminal Q of the flip-flop 443 turns L-level as shown in FIG. 3(e).

As described above, when the rated voltage of the switch SW4 for the outputting operation is assumed as the reference (100%), the detected voltage V3 is designed to be a voltage lower than the reference by a predetermined value, for example, to be 95% of the rated voltage of the switch SW4. In the boosting operation, the charge pump 30 changes from the first stage of the boosting operation to the second stage of the boosting operation when the voltage in the higher side of the boosting condenser C1, that is the voltage Vp in the connection node Np is detected as the detected voltage V3. At this time, it is controlled to connect the source voltage VDD and the boosting condenser C1 in series using the path including the resistor R31. Therefore, in the boosting operation, boosting voltage curve in the higher side of the boosting condenser C1 is gentle. This can prevent that the output voltage Vₒᵤₜ becomes over the rated voltage of the switch SW4 for the outputting operation.

### Second Exemplary Embodiment

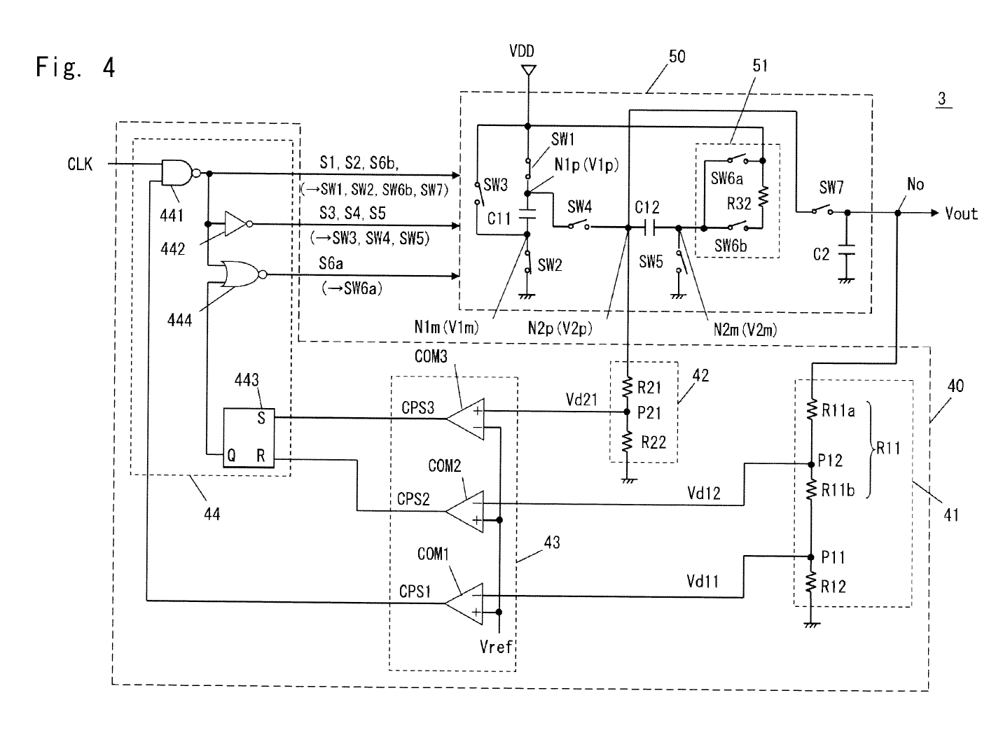

FIG. 4 is a circuit diagram of a booster circuit 3 according to a second exemplary embodiment in the present invention. The explanation for the same components as in FIG. 2 is omitted by giving the same reference symbols to the same components. The booster circuit 3 is the charge pump type and includes a charge pump 50 and a regulator 40. The booster circuit 3 boosts the source voltage VDD to the boosted voltage (the desired voltage) and supplies the boosted voltage as the output voltage Vₒᵤₜ to a load circuit (not shown). In this exemplary embodiment, the booster circuit 3 is described as a threefold boosting type.

The charge pump 50 includes switches SW1, SW2, SW3, SW4, SW5, SW6a, SW6b and SW7, a resistor R32, boosting condensers C11 and C12 and a smoothing condenser C2. The switch SW1 is connected between the source voltage VDD and a connection node N1p. The switch SW2 is connected between a connection node N1m and the ground voltage Gnd. The switch SW3 is connected between the source voltage VDD and the connection node N1m. The switch SW4 is connected between the connection node N1p and a connection node N2p. The switch SW5 is connected between the connection node Nm2 and the ground voltage Gnd. A switch for the boosting operation 51 is composed of the switches SW6a and SW6b and the resistor R32. In the switch for the boosting operation 51, the switch SW6a and the switch SW6b through the resistor R32 are connected in parallel. The switch for the boosting operation 51 is connected between the source voltage VDD and the connection node N2m. The switch SW7 is connected between the connection node N2p and the output node No. The boosting condenser C11 is connected between the connection nodes N1p and N1m. The boosting condenser C12 is connected between the connection nodes N2p and N2m. The smoothing condenser C2 is connected between the output node No and the ground voltage Gnd. The switches SW1, SW2, SW3, SW4, SW5, SW6a, SW6b and SW7 are composed of MOS transistors. The resistor R32 can be composed of an ON-resistance of the switch SW6b. In this case, it is only necessary to design the ON-resistance of the switch SW6b to be larger than an ON-resistance of the switch SW6a. The boosting condensers C11 and C12 and the smoothing condenser C2 are connected as external components to the IC chip.

The switches SW1, SW2, SW3, SW4. SW5, SW6a, SW6b and SW7 are respectively controlled by control signals S1, S2, S3, S4, S5, S6a, S6b and S7 supplied from the regulator 40. The switches SW1, SW2, SW3, SW4, SW5. SW6a, SW6b and SW7 turn ON at H-level in the control signals S1, S2, S3, S4, S5, S6a, S6b and S7 and turn OFF at L-level in the control signals.

The charge pump 50 sets the switches SW1 and SW2 to be ON-state and connects the source voltage VDD and the boosting condenser C11 in series to charge the boosting condenser C11 by the source voltage VDD. Hereinafter, this operation is referred to as a first charging operation. In the first charging operation, a voltage V1p in the connection node N1p is equal to a charged voltage V1c in the boosting condenser C11. When a charging of the boosting condenser C11 is saturated, the charged voltage V1c is approximately equal to the source voltage VDD.

The charge pump 50 sets the switch SW3 to be ON-state and connects the boosting condenser C11 in series with the source voltage VDD at the connection node N1m. The charge pump 50 boosts the source voltage VDD by the charged voltage V1c in the boosting condenser C11 and supplies a boosted voltage as a boosted voltage V1u from the connection node N1p. Hereinafter, this operation is referred to as a first boosting operation. The boosted voltage V1u, that is the voltage V1p in the connection node Nip, becomes a sum of the source voltage VDD and the charged voltage V1c by the first boosting operation.

The charge pump 50 sets the switches SW4 and SW5 to be ON-state to charge the boosting condenser C12 by the boosted voltage V1u from the connection node N1p. Hereinafter, this operation is referred to as a second charging operation. A voltage V2p in the connection node N2p becomes equal to the charged voltage V2c in the boosting condenser C12 by the second charging operation. When a charging of the boosting condenser C12 is saturated, a charged voltage V2c is approximately equal to a sum of the source voltage VDD and the charged voltage V1c, which is equal to 2×.VDD.

The charge pump 50 sets the switch SW6a or SW6b to be ON-state to connect the boosting condenser C12 in series with the source voltage VDD at the connection node N2m. The charge pump 50 boosts the source voltage VDD by the charged voltage V2c in the boosting condenser C12 and supplies a boosted voltage from the connection node N2p as a boosted voltage V2u. Hereinafter, this operation is referred to as a second boosting operation. The boosted voltage V2u, that is the voltage V2p in the connection node N2p, becomes a sum of the source voltage VDD and the charged voltage V2c by the second boosting operation. A boosting operation by the switch SW6b is performed through the resistor R32. The switch SW6b may be set to be OFF-state during a boosting operation in the switch SW6a, but the switch SW6b is set to be ON-state in this embodiment.

The charge pump 50 sets the switch SW7 to be ON-state to smooth the boosted voltage V2u from the connection node N2p using the smoothing condenser C2 and supplies a smoothed voltage as the output voltage Vₒᵤₜ from the output node No to the load circuit (not shown). Hereinafter, this operation is referred to as the outputting operation. The first charging operation, the second boosting operation and the outputting operation are performed concurrently, and the fist boosting operation and the second charging operation are performed concurrently. A set of the first charging operation, the second boosting operation and the outputting operation and a set of the fist boosting operation and the second charging operation are performed complementally.

An operation of the charge pump 50 will be described. Firstly, the charge pump 50 receives L-level control signals S1, S2, S6a, S6b and S7 and H-level control signals S3, S4 and S5. Therefore, the switches SW1, SW2, SW6a, SW6b and SW7 turn OFF and the switches SW3, SW4 and SW5 turn ON. The charge pump 50 is in the first boosting operation because of ON-state in the switch SW3 and also in the second charging operation because of ON-state in the switches SW4 and SW5.

The charge pump 50 receives H-level control signals S1, S2, S6a, S6b and S7 and L-level control signals S3, S4 and S5. Therefore, the switches SW1, SW2, SW6a, SW6b and SW7 turn ON and the switches SW3, SW4 and SW5 turn OFF. The charge pump 50 is in the first charging operation because of ON-state in the switches SW1 and SW2, the first stage of the second boosting operation because of ON-state in the switches SW6a and SW6b and the outputting operation because of ON-state in the switch SW7. The charge pump 50 receives H-level control signals S1, S2, S6b and S7 and L-level control signals S3, S4, S5 and S6a, and the switches SW1, SW2, SW6b and SW7 turn ON and the switches SW3, SW4, SW5 and SW6a turn OFF. The charge pump 50 is in the first charging operation because of the ON-state in the switches SW1 and SW2, in the second stage of the second boosting operation because of the ON-state in the switch S6b through the resistor R32, and in the outputting operation because of the ON-state in the switch S7. Because of a given time constant of the resistor R32, a boosting voltage curve in the boosted voltage V2u or the voltage V2p in the connection node N2p in the second stage of the second boosting operation is gentler than that in the first stage of the second boosting operation.

The control signal generating circuit 44 in the regulator 40 supplies the control signals S1, S2, S3, S4, S5, S6a, S6b and S7 to the charge pump 50. The output of the NAND circuit 441 is supplied to the charge pump 50 as the control signals S1, S2, S6b and S7. The output of the NOT circuit 442 is supplied to the charge pump 50 as the control signals S3, S4 and S5. The output of the NOR circuit 444 is supplied to the charge pump 50 as the control signal S6a.

An operation of the booster circuit 3 described above is the same as that of the booster circuit 2 and the explanation of it is omitted. That is, in the booster circuit 2, the charge pump 30 performs as a twofold boosting type pump. The booster circuit 2 performs the first stage of the boosting operation until the voltage Vp in the connection node Np is detected as the detected voltage V3 and performs the second stage of the boosting operation after the voltage Vp is detected as the voltage V3 in the boosting operation. On the other hand, in the booster circuit 3, the charge pump 50 performs as the threefold boosting type booster. The booster circuit 3 performs the first stage of the second boosting operation until the voltage V2p in the connection node N2p is detected as the detected voltage V3 and performs the second stage of the second boosting operation after the voltage V2p is detected as the voltage V3 in the second boosting operation. An operation in the regulator 40 in the booster circuit 3 is the same as that in the booster circuit 2.

As described above, when the rated voltage of the switch SW7 for the outputting operation is assumed as the reference (100%), the detected voltage V3 is designed to be a voltage lower than the reference by a predetermined value, for example, to be 95% of the rated voltage of the switch SW7. In the second boosting operation, the charge pump 50 performs the second stage of the second boosting operation when the voltage in the higher side of the boosting condenser C12, that is the voltage V2p in the connection node N2p is detected as the detected voltage V3. At this time, it is controlled to connect the source voltage VDD and the boosting condenser C12 in series through the resistor R32. Therefore, in the second boosting operation, boosting voltage curve in the higher side of the boosting condenser C12 is gentle. This can prevent that the output voltage Vₒᵤₜ becomes over the rated voltage of the switch SW7 for the outputting operation.

### Third Exemplary Embodiment

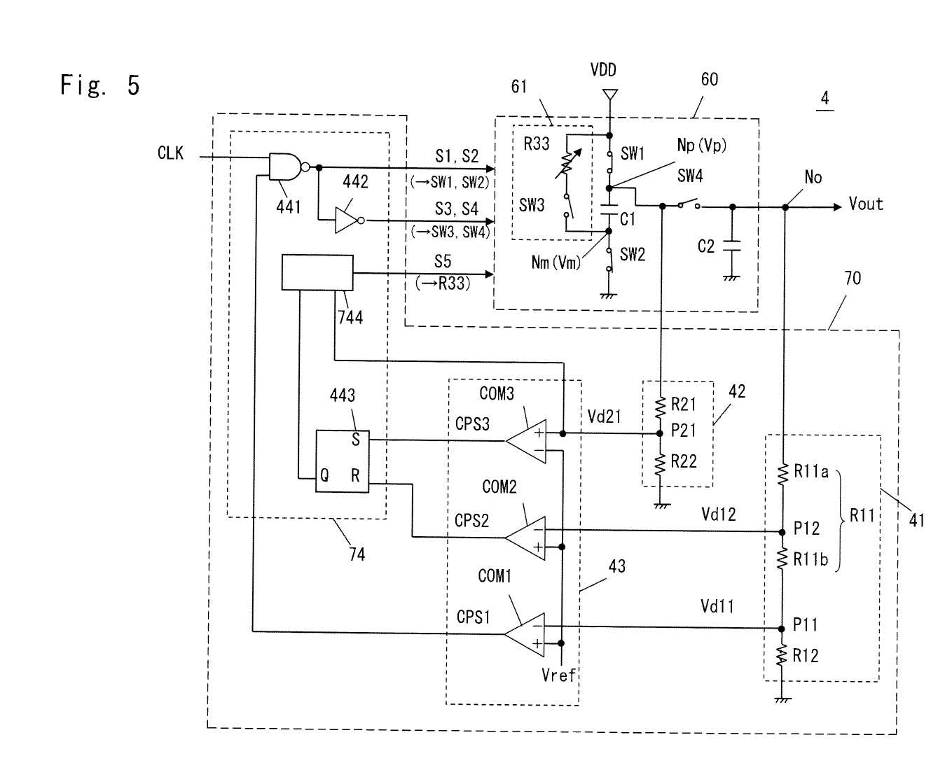

FIG. 5 is a circuit diagram of a booster circuit 4 according to a third exemplary embodiment in the present invention. The explanation for the same components as in FIG. 2 is omitted by giving the same reference symbols to the same components. The booster circuit 4 is the charge pump type and includes a charge pump 60 and a regulator 70. The booster circuit 4 boosts the source voltage VDD to the boosted voltage (the desired voltage) and supplies the boosted voltage as the output voltage Vₒᵤₜ to a load circuit (not shown). The booster circuit 4 is configured so that the source voltage VDD and the connection node Nm are connected with a switch through an adjustable resistor.

The charge pump 60 has the same configuration as the charge pump 30 in the booster circuit 2 in FIG. 2 except that the switch circuit for boosting operation 31 connected between the source voltage VDD and the connection node Nm is replaced with a switch for boosting operation 61. The switch for boosting operation 61 is composed of a switch SW3 and an adjustable resistor R33 connected in series. The switch SW3 is composed of an MOS transistor similarly to the switches SW1, SW2 and SW4.

The switch SW3 is controlled based on a control signal S3 supplied from the regulator 70. The switch SW3 turns ON at H-level in the control signal S3 and turns OFF at L-level of it. The charge pump 60 sets the switch SW3 to be ON-state to connect the boosting condenser C1 with the source voltage VDD in series at the connection node Nm. The charge pump 60 boosts the source voltage VDD by the charged voltage Vc in the boosting condenser C1 and supplies the boosted voltage as the boosted voltage Vu from the connection node Np. Hereinafter, this operation is referred to as a boosting operation. The boosted voltage Vu, that is the voltage Vp in the connection node Np by the boosting operation, becomes a sum of the source voltage VDD and the charged voltage Vc. A boosting operation by the switch SW3 is performed through the adjustable resistor R33. The adjustable resistor R33 is controlled by a control signal S5 from the regulator 70 and set to be a lower resistance value until the comparator COM3 detects the detected voltage V3. The adjustable resistor R33 is set to be a predetermined resistance value that increases according to the voltage Vp in the connection node Np after the comparator COM3 detects the detected voltage V3. The adjustable resistor R33 can be composed of an ON-resistance of the switch SW3. In this case, a gate voltage in the MOS transistor of the switch SW3 is controlled by the control signal S5 to vary ON-resistance value of the switch SW3.

An operation of the charge pump 60 will be described. Firstly, the charge pump 60 receives H-level control signals S1 and S2 and L-level control signals S3 and S4 and the switches SW1 and SW2 turn ON and the switches SW3 and SW4 turn OFF. Therefore, the charge pump 60 is in the charging operation. Next, the charge pump 60 receives L-level control signals S1 and S2, H-level control signals S3 and S4, and the control signal S5 that sets the adjustable resistance R33 to be the low resistance value. The switches SW1 and SW2 turn OFF, the switches SW3 and SW4 turn ON and the adjustable resistance R33 is set to be the low resistance value. Therefore, the charge pump 60 is in the first stage of the boosting operation which is performed through the adjustable resistance R33 and in the outputting operation because of the ON-state in the switch SW4. The charge pump 60 receives L-level control signals S1 and S2, H-level control signals S3 and S4, and the control signal S5 that sets the adjustable resistance R33 to be the predetermined resistance value higher than the low resistance value. The switches SW1 and SW2 turn OFF, the switches SW3 and SW4 turn ON and the adjustable resistance R33 is set to be the predetermined resistance value by the control signal S5. The charge pump 60 is in the second stage of the boosting operation performed through the adjustable resistor R33 which is set to be the predetermined resistance value by the control signal S5, and in the outputting operation because of ON-state in the switch SW4. Because of a given time constant of the resistor R33, a boosting voltage curve in the boosted voltage Vu or a voltage Vp of the connection node Np in the second stage of the boosting operation is gentler than that in the first stage of the boosting operation. Further, in the second stage of the boosting operation, the boosting voltage curve in the boosted voltage Vu or a voltage Vp becomes gentler with increasing the adjustable resistor R33.

The regulator 70 has the same configuration as the regulator 40 in the booster circuit 2 in FIG. 2 except that the control signal generating circuit 44 is replaced with a control signal generating circuit 74. Therefore, the regulator 70 includes the first voltage-dividing circuit 41, the second voltage-dividing circuit 42, the comparator 43 and the control signal generating circuit 74. The second voltage-dividing circuit 42 supplies the divided voltage Vd21 from a divided point P21 to the comparator 43 and to the control signal generating circuit 74.

The comparator 43 supplies the comparison results CPS1, CPS2 and CPS3 to the control signal generating circuit 74.

The control signal generating circuit 74 has the same configuration as the control signal generating circuit 44 in the booster circuit 2 in FIG. 2 except that the NOR circuit 444 is replaced with an adjustable resistor control signal generating circuit 744. Therefore, the control signal generating circuit 74 includes the NAND circuit 441, the NOT circuit 442, the RS flip-flop circuit 443 and the adjustable resistor control signal generating circuit 744. The control signal generating circuit 74 supplies the control signals S1, S2, S3, S4 and S5 to the charge pump 60. The NAND circuit 441 supplies the control signals S1 and S2 to the charge pump 60. The NOT circuit 442 supplies the control signals S3 and S4 to the charge pump 60. The RS flip-flop 443 supplies the voltage of the output terminal Q to the adjustable resistor control signal generating circuit 744. The adjustable resistor control signal generating circuit 744 receives the voltage of the output terminal Q of the RS flip-flop 443 and the divided voltage Vd21 and supplies the control signal S5 to the charge pump 60.

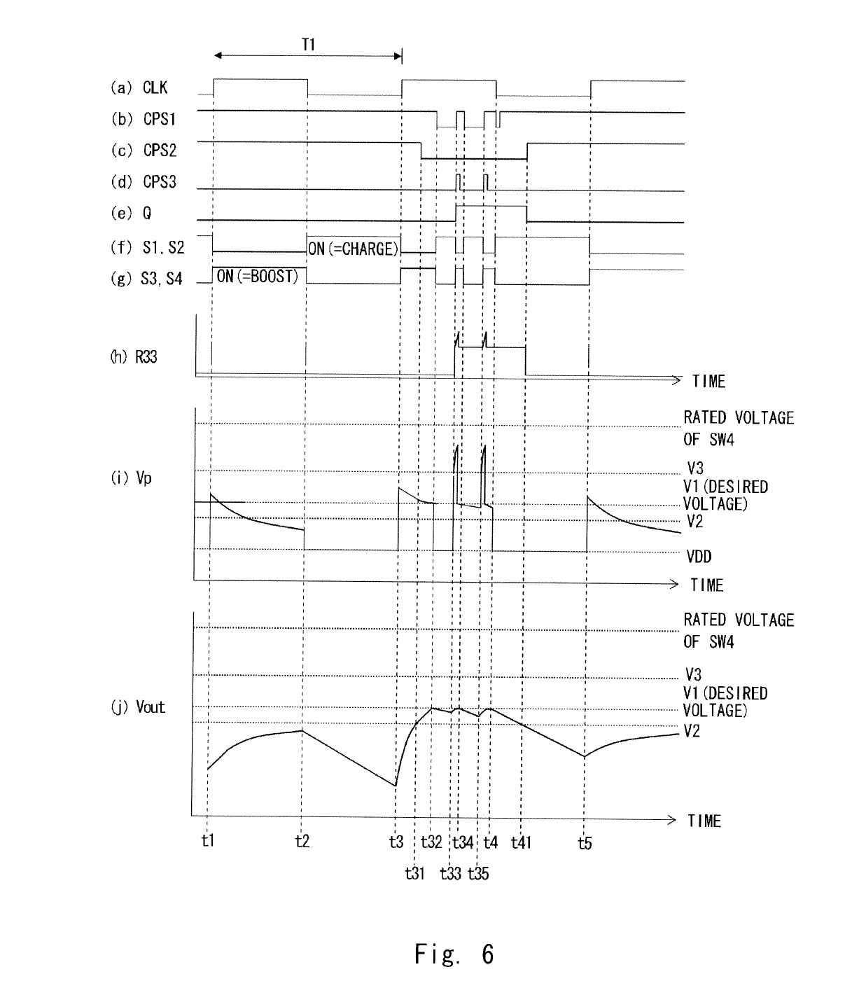

An operation of the booster circuit 4 as described above will be explained referring to FIG. 6. In an operation status (time t1 to t5), the booster circuit 4 receives the source voltage VDD, the reference voltage Vref and the ground voltage Gnd. In the operation status (time t1 to t5), the booster circuit 4 also receives the boosting clock CLK having a period T1 in which the boosting clock is logic H-level (referred to as just H-level) in the periods t1 to t2 and t3 to t4, and logic L-level (referred to as just L-level) in the periods t2 to t3 and t4 to t5 as shown in FIG. 6(a). In the operation status (time t1 to t5), the booster circuit 4 supplies the output voltage Vₒᵤₜ shown in FIG. 6(j) to the load circuit (not shown).

A voltage of the output node No, that is the output voltage Vₒᵤₜ, is divided by the first voltage-dividing circuit 41 and supplied to the comparator 43 as the divided voltages Vd11 and Vd12 from the first voltage-dividing circuit 41. The voltage Vp of the connection node Np is divided by the second voltage-dividing circuit 42 and supplied to the comparator 43 and the control signal generating circuit 74 as the divided voltage Vd21 from the second voltage-dividing circuit 42. The divided voltages Vd11, Vd12 and Vd21 are compared with the reference voltage Vref by the comparators COM1, COM2 and COM3 in the comparator 43. The divided voltages Vd11, Vd12 and Vd21 are output as the comparison results CPS1, CPS2 and CPS3 which are based on the output voltage Vₒᵤₜ and the voltage Vp as shown FIGS. 6(b), 6(c) and 6(d).

The boosting clock CLK is supplied to the control signal generating circuit 74. In the control signal generating circuit 74, the NAND circuit 441 performs logical NAND between the boosting clock CLK and the comparison result CPS1 which is determined based on the output voltage Vₒᵤₜ. The output of the NAND circuit 441 is supplied directly as the control signals S1 and S2 shown in FIG. 6(f) and also supplied to the NOT circuit 442. An output of the NOT circuit 442 is supplied as the control signals S3 and S4 shown in FIG. 6(g). In the control signal generating circuit 74, the RS flip-flop circuit 443 receives the comparison result CPS2 based the output voltage Vₒᵤₜ at the reset terminal R and the comparison result CPS3 based on the voltage Vp in the connection terminal Np at the set terminal S. The voltage of the output terminal Q of the RS flip-flop circuit 443 is output as shown in FIG. 6(e) and supplied together with the divided voltage Vd21 from the second voltage-dividing circuit 42 to the adjustable resistor control signal generating circuit 744. An output of the adjustable resistor control signal generating circuit 744 is supplied as the control signal S5 (not shown).

The control signals S1, S2, S3, S4 and S5 are supplied to the charge pump 60 from the control signal generating circuit 74. In the charge pump 60, the control signals S1, S2, S3 and S4 respectively control and set the switches SW1, SW2, SW3 and SW4 to ON-state at H-level. When the switches SW1 and SW2 are ON-state and the switches SW3 and SW4 are OFF-state, the charging pump 60 performs the charging operation. When the switches SW1 and SW2 are OFF-state, the switches SW3 and SW4 are ON-state, and the charge pump 60 receives the control signal S5, that varies based on the output voltage Vₒᵤₜ and the voltage Vp in the connection node Np and sets the adjustable resistor R33 to be the low resistance value as shown in FIG. 6(h), the charge pump 60 is in the first stage of the boosting operation and the outputting operation. When the switches SW1 and SW2 are OFF-state, the switches SW3 and SW4 are ON-state and the charge pump 60 receives the control signal S5 that sets the adjustable resistor R33 to be the predetermined voltage higher than the above mentioned low resistance value as shown in FIG. 6(h), the charge pump 60 is in the second stage of the boosting operation and the outputting operation.

Hereinafter, an operation of the booster circuit 4 using the control signals S1, S2, S3, S4 and S5 which are determined based on values of the output voltage Vₒᵤₜ and the voltage Vp of the connection node Np will be described.

(1) Period t1 to t2

The boosting clock CLK is H-level as shown in FIG. 6(a). Because the output voltage Vₒᵤₜ is lower than the detected voltages V1 and V2 as shown in FIG. 6(j), the comparison results CPS1 and CPS2 are H-level as shown in FIGS. 6(b) and 6(c). Therefore, the output of the NAND circuit 441, or the control signals S1 and S2, is L-level as shown in FIG. 6(f). The output of the NOT circuit 442, or the control signals S3 and S4, is H-level as shown in FIG. 6(g). Because the RS flip-flop 443 is reset by the comparison result CPS2, the output Q of the RS flip-flop 443 is L-level as shown in FIG. 6(e). Therefore, the output of the adjustable resistor control signal generating circuit 744, that is the control signal S5, is a signal that sets the resistance value of the adjustable resistor R33 to be low resistance value as shown in FIG. 6(h). As a result, in the period t1 to t2, the charge pump 60 is controlled to perform the first stage of the boosting operation and the outputting operation by the control signals S1, S2, S3, S4 and S5.

(2) Period t2 to t3

The boosting clock CLK is L-level as shown in FIG. 6(a). Therefore, the output of the NAND circuit 441, or the control signals S1 and S2, is H-level as shown in FIG. 6(f). The output of the NOT circuit 442, or the control signals S3 and S4 is L-level as shown in FIG. 6(g). As a result, in the period t2 to t3, the charge pump 60 is controlled to perform the charging operation by the control signals S1, S2, S3 and S4.

(3) Period t3 to t4

The boosting clock CLK is H-level as shown in FIG. 6(a). In the period t3 to t31, because the output voltage Vₒᵤₜ is lower than the detected voltages V1 and V2 as shown in FIG. 6(j), the control signals S1, S2, S3 and S4 are the same signal level as the period t1 to t2 as shown in FIGS. 6(f) and 6(g). At the time t31, because the output voltage Vₒᵤₜ is higher than the detected voltage V2 as shown in FIG. 6(j), the comparison result CPS2 turns L-level as shown in FIG. 6(c). In a period t31 to t32, because the voltage Vp of the connection node Np is lower than the detected voltage V3, the comparison result CPS3 remains L-level as shown in FIG. 6(d). Therefore, in this period, the output terminal Q of the RS flip-flop 443 remains L-level as shown in FIG. 6(e). In the same period, the output voltage Vₒᵤₜ is lower than the detected voltage V1 as shown in FIG. 6(j). Therefore, in the same period, the control signals S1, S2, S3 and S4 remain the same signal level as in the period t31 to t32 as shown in FIGS. 6(f) and 6(g), and the control signal S5 is still controlled to set the resistance value of the adjustable resistor R33 to be the low resistance value as shown in FIG. 6(h). As a result, in the period t3 to t32, the charge pump 60 is controlled to perform the first stage of the boosting operation and the outputting operation by the control signals S1, S2, S3, S4 and S5.

Next, at the time t32, because the output voltage Vₒᵤₜ becomes over the detected voltage V1 as shown in FIG. 6(j), the comparison result CPS1 turns L-level as shown in FIG. 6(b). Therefore, the output of the NAND circuit 441 turns H-level and the control signals S1, S2, S3 and S4 are the same signal level as the period t2 to t3 as shown in FIGS. 6(f) and 6(g) until the time t33 when the comparison result CPS1 turns H-level. As a result, in a period t32 to t33, the charge pump 60 is controlled to perform the charging operation by the control signals S1, S2, S3 and S4.

At the time t33, because the output voltage Vₒᵤₜ becomes equal to or lower than the detected voltage V1 with remaining higher than the detected voltage V2, the comparison result CPS2 remains L-level as shown in FIG. 6(c) and the comparison result CPS1 turns H-level as shown in FIG. 6(b). Therefore, the output of the NAND circuit 441 turns L-level and the control signals S1, S2, S3 and S4 remain the same signal level as the period t1 to t2 as shown in FIGS. 6(f) and 6(g) until the time t34. On the other hand, just after the time t33, because the voltage Vp of the connection node Np becomes higher than the detected voltage V3 as shown in FIG. 6(i), the comparison result CPS3 turns H-level as shown in FIG. 6(d). In synchronization with this operation, the output terminal Q of the RS flip-flop 443 turns H-level as shown FIG. 6(e) and remains H level until the RS flip-flop 443 is reset. Therefore, until the RS-flip-flop 443 is reset, the control signal S5 sets the resistance value of the adjustable resistance R33 to be the predetermined resistance value which increases according to the voltage Vp in the connection node Np as shown in FIG. 6(h). As a result, in a period t33 to t34, the charge pump 60 is controlled to perform the second stage of the boosting operation and the outputting operation by the control signals S1, S2, S3, S4 and S5.

In a period t34 to t35, the control signals S1, S2, S3 and S4 are in the same signal level as in the period t32 to t33 as shown in FIGS. 6(f) and 6(g). That is, in the period t34 to t35, the charge pump 60 is controlled to perform the charging operation by the control signals S1, S2, S3 and S4.

In the period t35 to t4, the control signals S1, S2, S3 and S4 turns the same signal level as in the period t33 to t34 as shown in FIGS. 6(f) and 6(g) and the control signal 55 is a signal which sets the resistance value of the adjustable resistor R33 to be the same signal level as in the period t33 to t34 as shown in FIG. 6(h). That is, in the period t35 to t4, the charge pump 60 is controlled to perform the second stage of the boosting operation and the outputting operation by the control signals S1, S2, S3, S4 and S5.

(4) Period t4 to t5

The boosting clock CLK is L-level as shown in FIG. 6(a). Therefore, the output of the NAND circuit 441 turns H-level and the control signals S1, S2, S3 and S4 are in the same signal level as in the period t2 to t3 as shown in FIGS. 6(f) and 6(g). As a result, in the period t4 to t5, the charge pump 60 is controlled to perform the charging operation by the control signals S1, S2, S3 and S4.

At a time t41, because the output voltage Vₒᵤₜ becomes lower than the detected voltage V2 as shown in FIG. 6(j), the comparison result CPS2 turns H-level as shown in FIG. 6(c). At this time, the RS flip-flop 443 is reset by the comparison result CPS2 and the output terminal Q of the flip-flop 443 turns L-level as shown in FIG. 6(e).

As described above, when the rated voltage of the switch SW4 which is for the outputting operation is assumed as the reference (100%), the detected voltage V3 is designed to be a voltage lower than the reference, for example by a predetermined value, to be 95% of the rated voltage of the switch SW4. In the boosting operation, the charge pump 60 changes from the first stage of the boosting operation to the second stage of the boosting operation when the voltage in the higher side of the boosting condenser C1, that is the voltage Vp in the connection node Np, is detected as the detected voltage V3. At this time, it is controlled to connect the source voltage VDD and the boosting condenser C1 in series through the resistor R33 whose resistance value is set to be the predetermined resistance value and increased according to the voltage Vp in the connection node Np. Therefore, in the boosting operation, boosting voltage curve in the higher side of the boosting condenser C1 changes gently. This can prevent that the output voltage Vₒᵤₜ becomes over the rated voltage of the switch SW4 which is for the outputting operation.

The first to the third exemplary embodiments can be combined as desirable by one of ordinary skill in the art.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

What is claimed is:

1. A booster circuit comprising:
a booster that connects a charged boosting condenser and a direct-current power source in series through a switch for a boosting operation to generate a boosted voltage and charges a smoothing condenser with the boosted voltage through a switch for an outputting operation,
wherein the switch for the boosting operation is composed of a plurality of switches connected in parallel and at least one of the plurality of switches can be controlled independently.

2. The booster circuit according to claim 1, wherein the switch for the boosting operation is composed of a plurality of switches connected in parallel and at least one of the plurality of switches has an ON-resistance value different from an ON-resistance value in the other switches.

3. The booster circuit according to claim 1, further comprising a measuring component that measures a voltage of the smoothing condenser,
wherein the boosting condenser is controlled according to a measured voltage of the smoothing condenser so that the booster circuit outputs a voltage lower than a sum of a charged voltage in the boosting condenser and a voltage of the direct-current power source.

4. The booster circuit according to claim 3, wherein the switch for the boosting operation is controlled to increase a resistance value of the switch for the boosting operation when it is detected that the measured voltage becomes over a predetermined voltage.

5. A booster circuit comprising:
a boosting condenser; and
a control circuit that switches a charging operation and a boosting operation, the charging operation is the one in which the boosting condenser is connected to a first path between a first voltage and a second voltage lower than the first voltage to charge the boosting condenser, a boosting operation is the one in which a connection destination of a lower side of the charged boosting condenser is switched from the second voltage to the first voltage or a third voltage higher than the first voltage to generate a boosted voltage at a higher side of the boosting condenser,
wherein the control circuit varies a resistance of a boosting path that connects the lower side of the boosting condenser with the first voltage or the third voltage according to a voltage in the higher side of the boosting condenser in the boosting operation.

6. The booster circuit according to claim 5, wherein when the voltage in the higher side of the boosting condenser is higher than a predetermined reference, the resistance of the boosting path is set to be larger than a resistance which is set at the time when the voltage in the higher side of the boosting condenser is lower than the predetermined reference.

7. The booster circuit according to claim 6, further comprising:
a first path capable of connecting the lower side of the boosting condenser selectively to the first voltage or the third voltage; and
a second path having a resistance value larger than the first path and capable of connecting the lower side of the boosting condenser selectively to the first voltage or the third voltage,
wherein the control circuit selects the first path when the voltage in the higher side of the boosting condenser is lower than the predetermined reference and selects the second path when the voltage in the higher side of the boosting condenser is higher than the predetermined reference.

8. The booster circuit according to claim 5, further comprising:
a first path that includes a first switch component capable of connecting the lower side of the boosting condenser selectively to the first voltage or the third voltage; and
a second path that includes a second switch component capable of connecting connects the lower side of the boosting condenser selectively to the first voltage or the third voltage and has a resistance larger than the first path,
wherein the control circuit can control the first switch and the second switch independently.

9. The booster circuit according to claim 8, wherein the control circuit sets at least the first switch component to be ON-state when the voltage in the higher side of the boosting condenser is lower than the predetermined reference and sets the first switch component to be OFF-state and the second switch component to be ON-state when the voltage in the higher side of the boosting condenser is higher than the predetermined reference.

10. The booster circuit according to claim 8, wherein the first and the second switch components are MOS transistors and the difference between the resistance of the first path and the second path is due to the difference between the ON-resistance of the first and the second switch components.

11. The booster circuit according to claim 5, further comprising an adjustable resistor arranged in the boosting path,
wherein the control circuit varies the resistance value of the adjustable resistor according to the voltage in the higher side of the boosting condenser.
